(19) United States
(12) Patent Application Publication
(10) Pub. No.: US 2016/0224952 A1
(43) Pub. Date: Aug. 4, 2016

(54) PAYMENT SYSTEM, PAYMENT DEVICE, PAYMENT METHOD AND PROGRAM

(71) Applicant: NEC CORPORATION, Tokyo (JP)

(72) Inventor: Atsushi KOZATO, (US)

(21) Appl. No.: 14/917,554

(22) PCT Filed: Sep. 11, 2014
(86) PCT No.: PCT/JP2014/004678

§ 371 Date: Mar. 8, 2016

(51) Int. Cl. G06Q 20/10

(52) U.S. Cl. CPC G06Q 20/102

(57) ABSTRACT

The objective of the present invention is to provide a payment system, a payment device and a payment method, which reduce the load of an operation process, in a payment process, of setting a predetermined digit of a balance to be a predetermined number, and accordingly complete the payment process in a short time.

One aspect of the present invention is a payment system performing a payment process on a balance held in a medium in the form of electronic data, the payment system comprising: an operation unit for updating a balance by the use of an operational amount calculated based on both a payment amount and the balance, and thereby obtaining an updated balance; and an operational amount calculation unit for calculating the operational amount in a manner to set a predetermined digit of the updated balance to be a predetermined number.

### TECHNICAL FIELD

The present invention relates to a payment system, a payment device, a payment method and a program, and in particular, relates to a payment system, a payment device, a payment method and a program which performs a payment process on a balance of electronic money held in a medium in the form of electronic data, and accordingly updates the balance.

### BACKGROUND ART

Electronic money is one of electronic payment systems, and is a method of performing payment for a transaction in currency by means of electronic data.

One example of electronic money is an IC-chip type one where a recording medium such as an electronic chip is embedded in a card or the like, and electronic data according to an amount designated by the user is recorded in the electronic chip by prior operation. Here, “IC” is an abbreviation of “Integrated Circuit”.

In the IC-chip type electronic money, a money amount stored in the electronic chip is updated during payment at a time of the user's purchase. The IC-chip type electronic money has increased user convenience greatly, because of the fact such as that it makes it unnecessary to carry bills and coins, to count bills and coins, and to change a large denomination bill into small denomination bills.

Further, it has greatly reduced time for boarding at a time of using public transportation, such as by making it possible to perform payment for the fare directly at a ticket gate instead of purchasing a ticket for the destination.

Virtual money used for transactions in a computer network, where payment is carried out by operating a terminal, also is an example of electronic money. The virtual money is held in a storage means in an electronic device such as a server, and is transferred via the network.

Patent Literature 1 discloses a charging server which performs payment for purchase of a product by the use of virtual money, and an information communication system where operation of purchasing a product is performed on the charging server by the use of a first communication device. In the information communications system disclosed in Patent Literature 1, the first communication device, such as an LCD TV, and a second communication device, such as a cellular phone, perform data communication with each other, and a process of purchasing a product is performed using a function of the cellular phone, or the like. A process of charging for the product is performed between the first communication device and the charging server or between the second communication device and the charging server.

Patent Literature 2 discloses a mobile terminal device which stores charge information about payment on IC-chip type electronic money, with a charge type being related to the information. In the mobile terminal device disclosed in Patent Literature 2, a usage history stored in the IC chip is read, and then referring to the charge type information stored in advance, each piece of charge information in the usage history is distinguished whether being charge information on a specific usage or not.

Patent Literature 3 discloses an electronic coin issuing server which issues electronic coins which a user can use for a vending machine when purchasing a product from the vending machine. The user purchases a product from a vending machine by the use of the issued electronic coins, and the electronic coin issuing server debits the payment amount from the user's account.

Patent Literature 4 discloses an IC card which itself performs counting on payment data and, on reach at a predetermined value, performs charging by sending notification to a server. In the IC card disclosed in Patent Literature 4, the communication cost is reduced, because the counted values of usage amount are managed and it is possible to send small counted values to the server collectively at one time after sequentially summing up them.

Patent Literature 5 discloses an electronic cash system for electronic wallet comprising a payment terminal with which a user performs payment and an authorization center. In the electronic cash system for electronic wallet disclosed in Patent Literature 5, the authorization center verifies the validity of a card, checks the solvency of the card holder when a purchase amount exceeds a predetermined value, and periodically collects all transactions via a switched telephone network. Then, a compensation system transfers electronic money from the card user's bank account to the shopkeeper's bank account.

Patent Literature 6 discloses a bank account saving system in which, on every occurrence of a transaction of deposit into or withdrawal from a depositor's account, a fraction of a predetermined number of digits in the balance or a money amount corresponding to a predetermined proportion of the balance is transferred to an account designated by the depositor.

### CITATION LIST

### Patent Literature

### [Patent Literature 1] Japanese Patent Application Laid-Open No. 2010-271779

### [Patent Literature 2] Japanese Patent Application Laid-Open No. 2010-011245

### [Patent Literature 3] Japanese Patent Application Laid-Open No. 2004-185253

### [Patent Literature 4] Japanese Patent Application Laid-Open No. 2004-171270

[Patent Literature 5] Published Japanese translation of PCT application No. 2004-534338

### [Patent Literature 6] Japanese Patent Application Laid-Open No. 2012-123489

### SUMMARY OF INVENTION

### Technical Problem

For a user of electronic money, there is assumed a state of using electronic money similar to a situation of paying with cash.

That is, when small denomination coins such as one-yen or five-yen coins are returned as a result of paying with cash, there is a case the small denomination coins are used for another usage or discarded before the next payment, not being held in a wallet. In a case of cash, when a collection box is located at the site where payment has been made, it is possible to put such small denomination coins into the collection box and thereby avoid holding them in a wallet. If not doing that way and accordingly keeping a large number of coins remaining in a wallet, selection among the coins becomes necessary in the next payment to take desired ones out of the wallet, and the payment process accordingly becomes troublesome.

It is the same in a case of electronic money, where an amount less than 10 yen causes increase in the number of digits of a balance, and accordingly makes the user necessary to be aware of a number having one more digit, in payment. For this reason, for a user disliking that the calculation becomes complicated, the increase in the number of digits has been a problem.

Also in a case of electronic money, by moving or deleting an amount less than 10 yen, generated as a result of payment, accordingly making the last digit of the balance zero, and thereby making the balance be an amount having one less digit, comfortable use of electronic money becomes possible.

In the terminal devices or payment systems for performing payment with electronic money disclosed in Patent Literature 1 to Patent Literature 5, no description is given of a process performed when a fraction is generated at the last digit.

In contrast to that, in the bank account saving system disclosed in Patent Literature 6, a bank account transaction processing means comprises a fraction transfer means. In a transaction process of deposit or withdrawal money, the fraction transfer means distinguishes whether or not a fraction is present in the account balance, and if it is, the fraction is subtracted from the account balance.

FIG. 8 shows a configuration of a charging system of related technology in which, in response to a charging request from a charging server, data held in an electronic money card is read, and the charge amount is subtracted from the balance of the card. Hereinafter, with respect to the related technology, a description will be given of a charging system which, when a fraction is generated at the last digit of the balance of the card, sets the last digit to be zero by discarding the fraction.

The charging system 2001 comprises an electronic money reading device 2021 which reads an electronic money card 2011 and a charging server 2031 connected with the electronic money reading device 2021 via a communication link.

Electronic money is held in the electronic money card 2011. When the electronic money card 2011 is made to be in contact with an electronic money reading unit 2022 of the electronic money reading device 2021, the balance of electronic money corresponding to data stored in the card is referred to by the electronic money reading device 2021.

After a charging process, the electronic money reading device 2021 overwrites the balance of the electronic money card 2011 with the processed data.

A reading device control unit 2023 of the electronic money reading device 2021 confirms the validity of the electronic money card 2011.

When a charging request is generated from the charging server 2031, the balance of electronic money is notified to the charging server 2031 via a data sending/reception unit 2024 and the communication link. The balance of electronic money is processed in a charge processing unit 2041 of the charging server 2031.

After the charging process, the processed data is notified to the electronic money reading device 2021, and is written into the electronic money card 2011 via the electronic money reading unit 2022.

FIG. 9 is a block diagram showing a configuration of the charge processing unit 2041 in the related technology. FIG. 10 is a flow chart showing a process procedure of a charging method in the related technology. For the sake of simplicity, a description will be given of a process of subtracting an amount corresponding to a fraction from a balance when the fraction has been generated as a result of charging.

In FIG. 9, a balance of electronic money recorded in the electronic money card 2011 is held in a balance holding section 2101.

When a charging request is generated in the charging server 2031, the charge amount is held in a charge amount holding unit 2302. The balance of electronic money held in the balance holding section 2101 is copied to a buffer 2403 of the charge processing unit 2041.

Next, in an operation section 2401 of the charge processing unit 2041, subtraction operation is performed on the basis of the charge amount held in the charge amount holding unit 2302 and the balance of electronic money held in the buffer 2403 (FIG. 10, step S401). With the result of the operation, the balance of electronic money held in the buffer 2403 is overwritten.

Referring to the balance of electronic money held in the buffer 2403, a fraction determination section 2404 determines whether or not a fraction has been generated at a predetermined digit of the balance of electronic money (step S402).

Whether or not a fraction has been generated in the balance of electronic money is determined by, for example, whether the remainder of dividing the balance of electronic money by 10 is zero or not. The fraction determination section 2404 notifies a fraction amount holding section 2405 of the remainder, as a fraction amount (step S403).

If a fraction has been generated (YES at the step S402), receiving an order from the fraction determination section 2404, the operation section 2401 performs operation of subtracting the fraction held in the fraction amount holding section 2405 from the balance of electronic money held in the buffer 2403 (step S404). With the operation result, the balance of electronic money held in the buffer 2403 is overwritten again.

When the charging process is completed, the balance holding section 2101 of the electronic money card 2011 is overwritten with the balance of electronic money held in the buffer 2403. Further, the balance of electronic money after the processing is written into a charge data holding unit 2301.

Here, the fraction generated in the above-described charging process is discarded, or is held in the fraction amount holding section 2405 and used in another process of saving or the like by being notified to a fraction processing section, which is not illustrated in the drawing.

In the related technology, there may be a case where, even if the charging amount is a small one, subtraction operation by the operation section 2401 may need to be performed twice, as described above. Additionally, for determining whether or not a fraction is present in the balance of electronic money obtained as a result of the operation, another operation is required. During the process of determining whether a fraction is present or not, the operation section 2401 waits for an order on whether or not to perform the process of subtracting a fraction, and completion of the charging process is delayed by a corresponding amount of time. There accordingly is a problem in that, when the charging process is operated via a communication link in an environment where the communication link is used in a pay-for-use system, the usage fee of the communication link increases if the charging process takes time.

The present invention is made in view of the above-described point, and accordingly is aimed at providing a payment system, a payment device and a payment method, all for electronic money, which reduce the load of an operation process, in a payment process, of setting a predetermined digit of a balance to be a predetermined number, and accordingly complete the payment process in a short time.

### Solution to Problem

In order to achieve the above-described objective, a payment system of the present invention includes: an operation means for updating a balance held in a medium in the form of electronic data by the use of an operational amount calculated on the basis of a payment amount and the balance, and thereby obtaining an updated balance; and an operational amount calculation means for calculating the operational amount in a manner to set a predetermined digit of the updated balance to be a predetermined number.

A payment device of the present invention includes: an operation means for updating a balance held in a medium in the form of electronic data by the use of an operational amount calculated on the basis of a payment amount and the balance, and thereby obtaining an updated balance; and an operational amount calculation means for calculating the operational amount in a manner to set a predetermined digit of the updated balance to be a predetermined number.

A payment method of the present invention includes: calculating, on the basis of a payment amount and a balance held in a medium in the form of electronic data, an operational amount in a manner to set a predetermined digit of an updated balance to be a predetermined number; and updating the balance by the use of the calculated operational amount and thereby obtaining the updated balance.

A payment program of the present invention is characterized by causing a computer to execute: an operational amount calculation process of calculating, on the basis of a payment amount and a balance held in a medium in the form of electronic data, an operational amount in a manner to set a predetermined digit of an updated balance to be a predetermined number; and an operation process of updating the balance by the use of the calculated operational amount and thereby obtaining the updated balance.

### Advantageous Effects of Invention

According to the present invention, it is possible to reduce the load of an operation process, in a payment process on electronic money, and accordingly complete the payment process in a short time.

### BRIEF DESCRIPTION OF DRAWINGS

FIG. 1 A diagram showing an example of a configuration of a payment system according to a first exemplary embodiment of the present invention

FIG. 2 A diagram showing an example of a configuration of a payment processing unit in the payment system according to the first exemplary embodiment of the present invention

FIG. 3 A diagram showing an example of a configuration of a payment system according to a second exemplary embodiment of the present invention

FIG. 4 A diagram showing an example of a configuration of a payment processing unit in the payment system according to the second exemplary embodiment of the present invention

FIG. 5 A flow chart showing an example of a process of a payment method according to the second exemplary embodiment of the present invention

FIG. 6 A flow chart showing an example of an operational amount calculation process of the payment method according to the second exemplary embodiment of the present invention

FIG. 7 A diagram showing a modified example of a configuration of the payment system according to the second exemplary embodiment of the present invention

FIG. 8 A diagram showing a configuration of a charging system in related technology

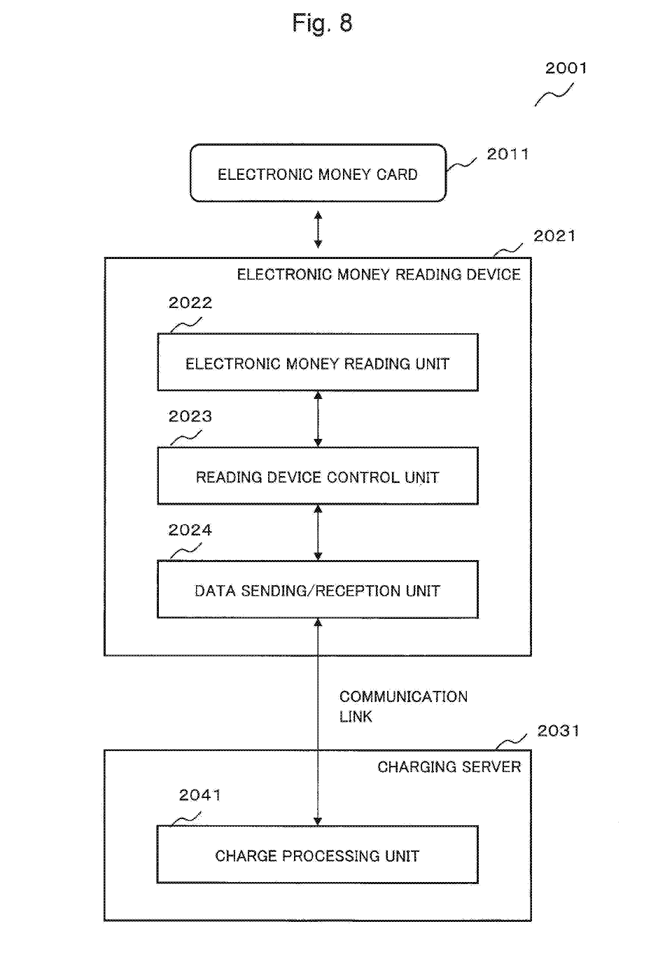

FIG. 9 A diagram showing a configuration of a charge processing unit in the charging system in related technology

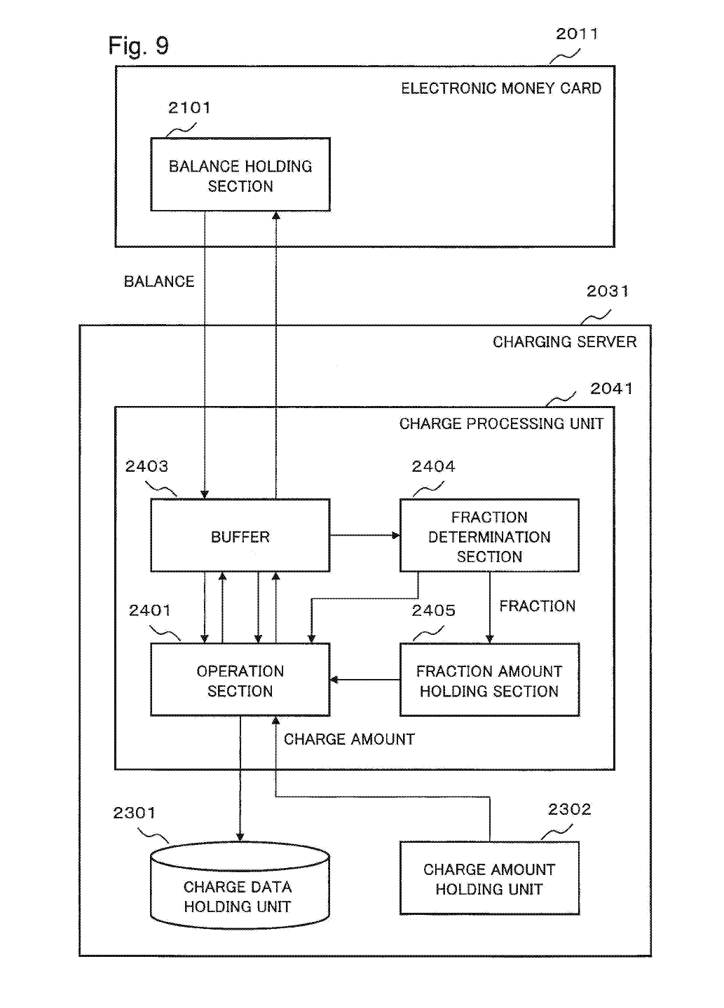

FIG. 10 A flow chart showing a process of a charging method in related technology

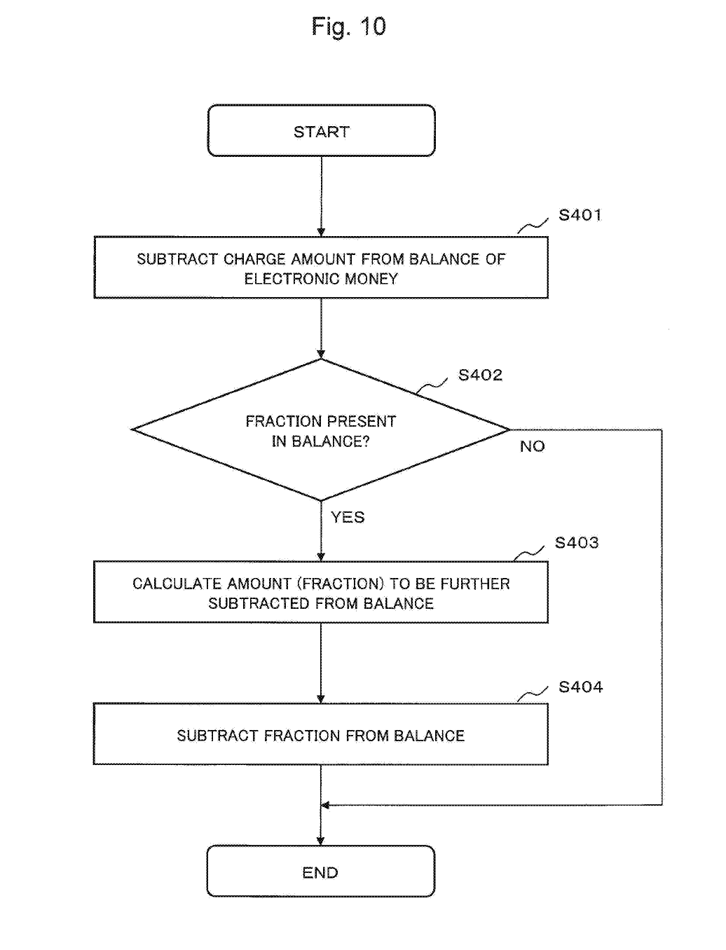

### DESCRIPTION OF EMBODIMENTS

Hereinafter, exemplary embodiments for implementing the present invention will be described in detail, with reference to the drawings. However, the present invention is not limited to exemplary embodiments described below.

### First Exemplary Embodiment

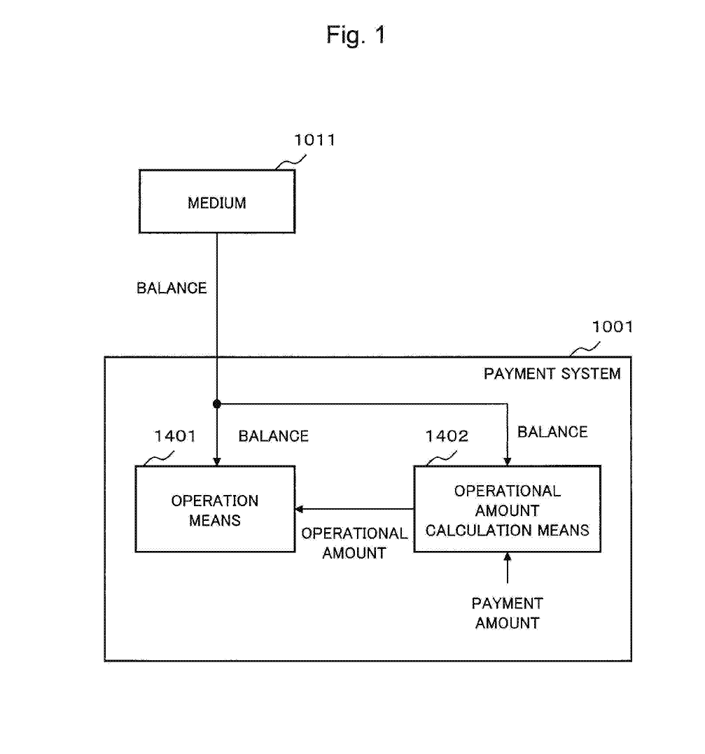

FIG. 1 shows an example of a configuration of a payment system according to a first exemplary embodiment of the present invention.

The payment system 1001 according to the present exemplary embodiment is a payment system which performs a payment process on a balance held in a medium 1011 in the form of electronic data. The payment system 1001 comprises an operational amount calculation means 1402 which calculates an operational amount on the basis of a payment amount and the balance, and an operation means 1401 which updates the balance on the basis of the operational amount and thereby obtains an updated balance.

The operational amount calculation means 1402 calculates the operational amount in a manner to set a predetermined digit of the updated balance to be a predetermined number.

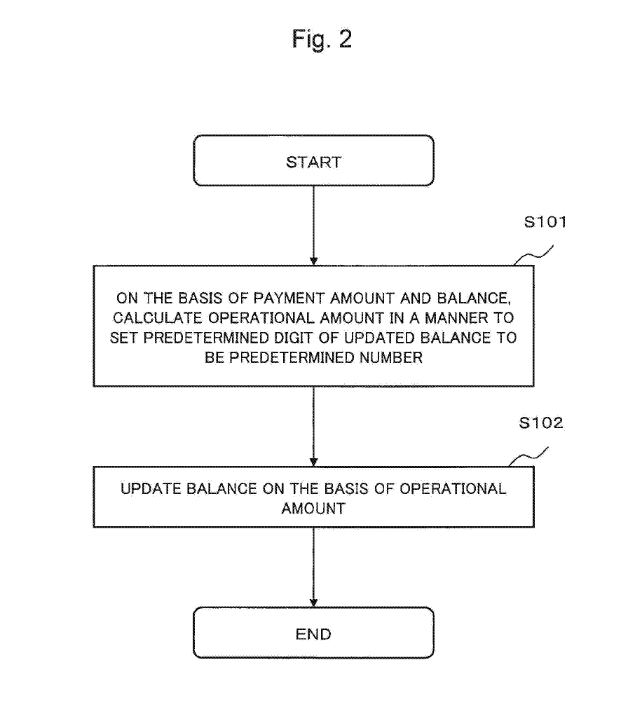

FIG. 2 shows an example of a process of a payment method according to the first exemplary embodiment of the present invention.

The payment method according to the present exemplary embodiment is the one which performs a payment process on a balance held in a medium in the form of electronic data and accordingly updates the balance.

An operational amount is calculated on the basis of a payment amount and the balance, in a manner to set a predetermined digit of the balance after update to be a predetermined number (FIG. 2, step S101), and the balance is updated on the basis of the operational amount, by which an updated balance is obtained (step S102).

In the payment system 1001 according to the present exemplary embodiment, the load of an operation process relating to a payment process on a balance held in a medium is reduced, and accordingly, it is possible to reduce time necessary for the payment process.

### Second Exemplary Embodiment

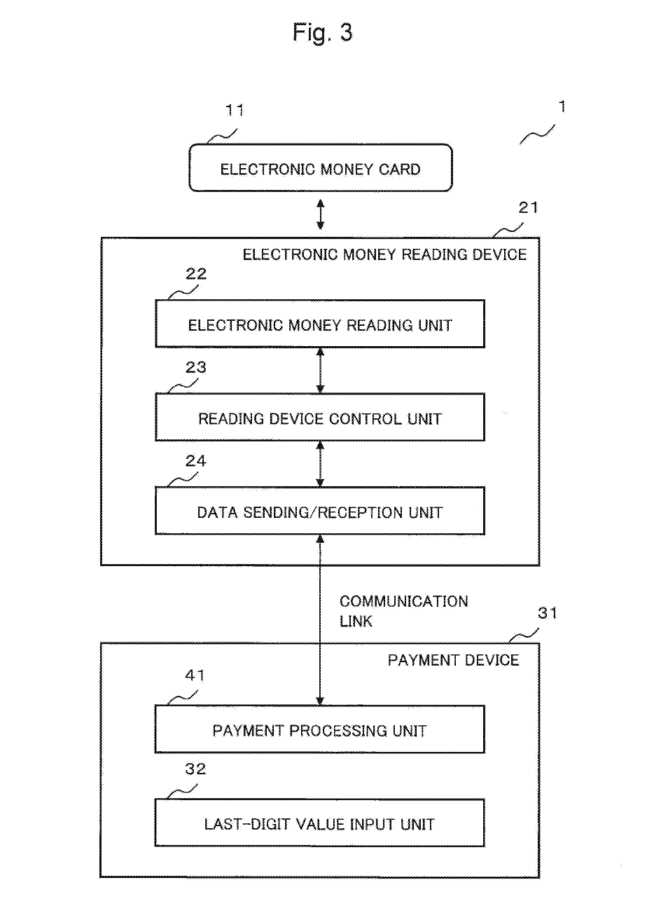

FIG. 3 shows an example of a configuration of a payment system according to a second exemplary embodiment of the present invention.

The payment system 1 comprises an electronic money reading device 21 which reads an electronic money card 11, and a payment device 31 connected with the electronic money reading device 21 via a communication link.

In response to a charging request from the payment device 31, the electronic money reading device 21 reads the data held in the electronic money card 11 and notifies the payment device 31 of the data.

The payment device 31 may be provided with a last-digit value input unit 32 by which a user inputs a last digit value.

As the electronic money card 11, a magnetic card or a contactless IC card is used. Electronic money is held in the electronic money card 11 in the form of electronic data. When the electronic money card 11 is made to be in contact with or close to an electronic money reading unit 22 of the electronic money reading device 21, the balance of electronic money corresponding to the held data is read out.

When a magnetic card is used, communication between the electronic money card 11 and the electronic money reading unit 22 is performed such that the electronic money reading unit 22 becomes in contact with a magnetic area in the electronic money card 11 and thereby reads the magnetic data. When a contactless IC card is used, sending and reception of electronic money data is performed by means of near field communication performed between the electronic money card 11 and the electronic money reading unit 22.

The electronic money reading device 21 writes processed data into the electronic money card 11, after the payment process is completed. A reading device control unit 23 of the electronic money reading device 21 confirms the validity of the electronic money card 11.

When a payment request is generated from the payment device 31, the balance of electronic money is notified to the payment device 31 via a data sending/reception unit 24 and the communication link. The balance of electronic money is processed in a payment processing unit 41 of the payment device 31. After completion of the payment process, processed data is notified to the electronic money reading device 21, and then is written into the electronic money card 11.

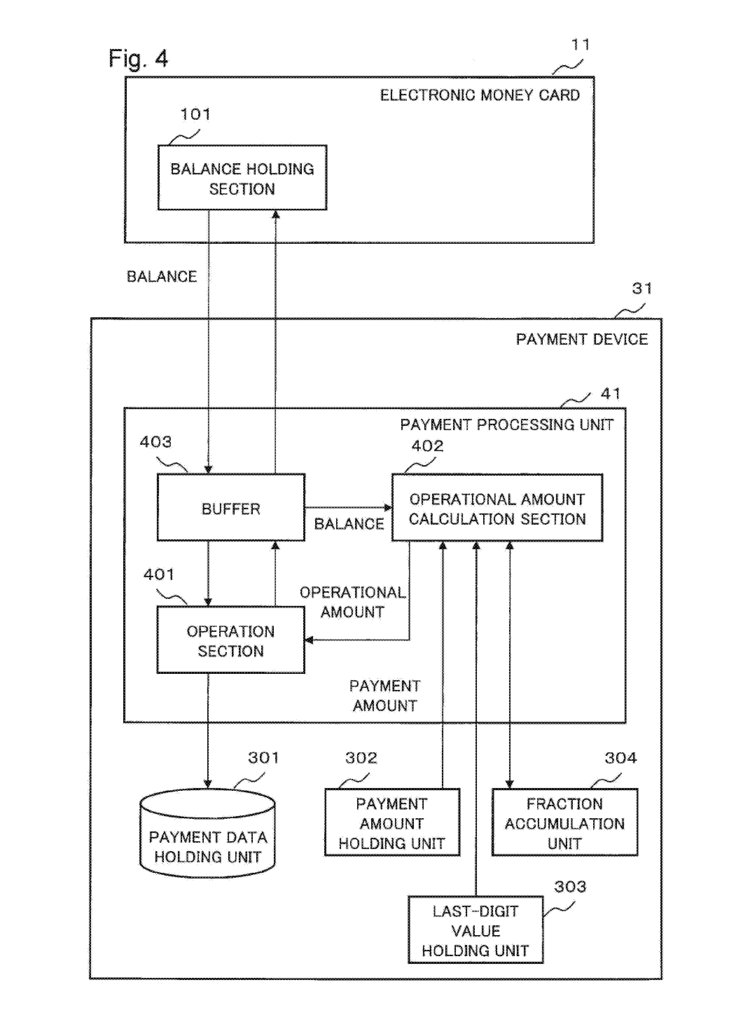

FIG. 4 shows an example of a configuration of the payment processing unit 41 in the payment system according to the present exemplary embodiment.

The payment processing unit 41 comprises a buffer 403, an operational amount calculation section 402 and a operation section 401.

The electronic money card 11 includes a balance holding section 101, and the balance of electronic money held by the electronic money card 11 is recorded in the balance holding section 101. After a payment process is completed, the balance held in the balance holding section 101 is overwritten with an updated balance. In the balance holding section 101, as a payment history, supplementary data such as the updated balance and the date and time of the payment process may be recorded, along with the balance before update.

The payment device 31 further includes a payment data holding unit 301 which stores a money amount relating to the payment process and a payment amount holding unit 302 which holds a payment amount. The last digit value described above is held in a last-digit value holding unit 303. The user may input the last digit value by the use of the last-digit value input unit 32.

The buffer 403 performs sending and reception of data to and from the balance holding section 101 of the electronic money card 11 via the electronic money reading device 21, the data sending/reception unit 24 and the communication link, which are shown in FIG. 3. The operation section 401 communicates with the payment data holding unit 301. The operational amount calculation section 402 communicates with the payment amount holding unit 302.

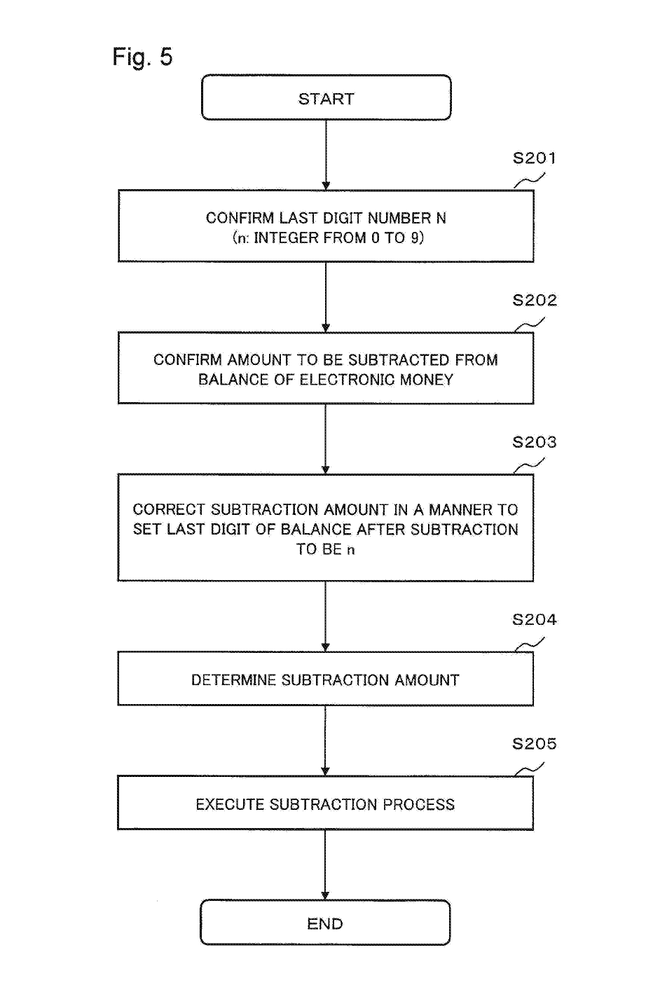

FIG. 5 is a flow chart showing an example of a procedure of the payment process according to the present exemplary embodiment.

Hereinafter, for the sake of simplicity, a description will be given of a payment process of subtracting a requested amount, which is performed on the balance of electronic money.

When a payment request is generated, first, the balance of electronic money held in the balance holding section 101 of the electronic money card 11 is copied to the buffer 403.

Next, a number n to be set for the last digit of the balance after the payment process is confirmed (FIG. 5, step S201).

The last digit number n is an integer from 0 to 9, which has been set by the user at start-up of the payment system, or the like, and held in the last-digit value holding unit 303. The operational amount calculation section 402 refers to the last-digit value holding unit 303 for the last digit number n. The last digit number n may be inputted or changed through operation by the user at the last-digit value holding unit 303. The setting may be changed to the one where designation of the last digit number is not performed.

Then, a payment amount is held in the payment amount holding unit 302 of the payment device 31, and is notified to the operational amount calculation section 402 (step S202).

Next, on the basis of the balance of electronic money held in the buffer 403 and the payment amount notified from the payment amount holding unit 302, the operational amount calculation section 402 calculates an amount to be subtracted from the balance of electronic money (step S203).

Here, the difference between the payment amount and the subtraction amount calculated by the operational amount calculation section 402 may be discarded as a fraction generated in the subtraction amount calculation, or may be saved in a fraction accumulation unit 304.

When an amount equal to or larger than a predetermined one has been accumulated in the fraction accumulation unit 304, a subtraction amount may be calculated after transferring part of the accumulated amount from the fraction accumulation unit 304 to the operational amount calculation section 402, in a manner to set the last digit of the balance after the payment process to be n.

The calculated subtraction amount is notified from the operational amount calculation section 402 to the operation section 401 (step S204), and then in the operation section 401, a process of subtracting the subtraction amount from the balance of electronic money held in the buffer 403 is performed (step S205).

When the subtraction process is completed, the balance of electronic money held in the buffer 403 is overwritten with the result of the subtraction process, and the result is further sent to the balance holding section 101 of the electronic money card 11. The result of the subtraction process is notified to the payment data holding unit 301 of the payment device 31, and the payment process is thereby completed.

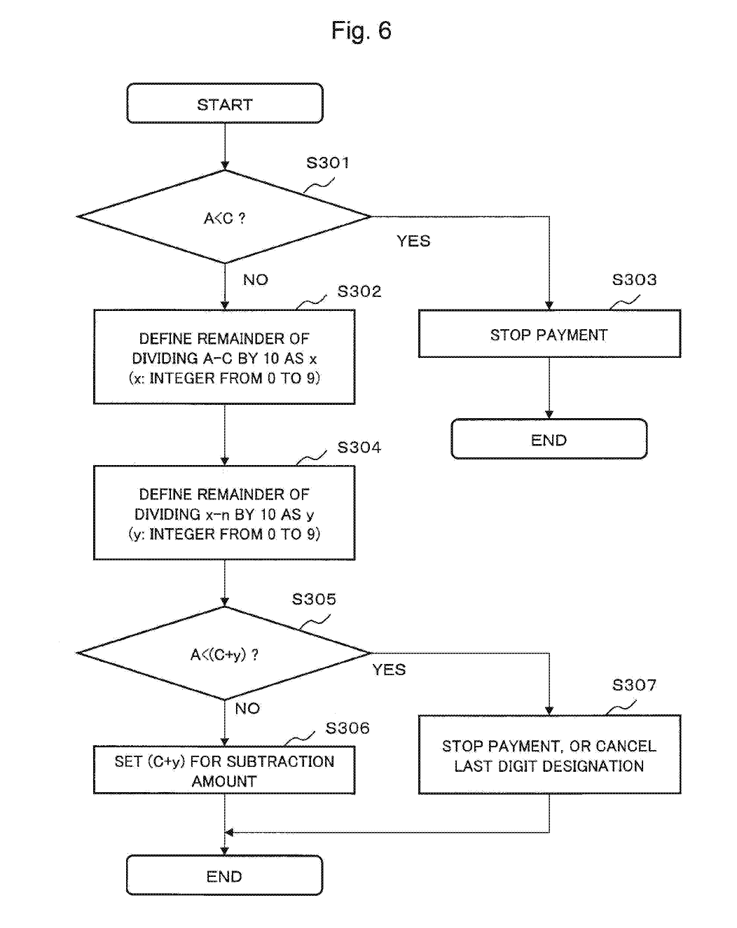

Next, a subtraction amount calculation method used in the step S203 of FIG. 5 will be described in detail, with reference to FIG. 6.

Here, the balance of electronic money is represented by A, and the amount whose subtraction is ordered by the payment request is represented by C.

First, a determination is made on whether the subtraction from the balance of electronic money is possible or not, that is, whether A is larger than or equal to C or not (FIG. 6, step S301). If A is smaller than C (YES at the step S301), the payment process is impossible and accordingly is stopped by notifying the result to the payment device 31 (step S303).

If the subtraction from the balance of electronic money is possible (NO at the step S301), the difference, (A−C), between the balance of electronic money and the ordered subtraction amount is divided by 10, and the remainder of the division is defined as x (step S302).

When the last digit number is to be n for the balance after the payment process obtained by subtracting the ordered subtraction amount C from the balance of electronic money A, the remainder of dividing the difference between x and n, (x−n), by 10 is defined as y (step S304). The amount to be subtracted at the operation section 401 comes to be the sum of C and y (step S306). Here, each of n, x and y is an integer from 0 to 9. If x is smaller than n, the result of subtracting n from the sum of x and 10 is set for y.

If the sum of C and y, (C+y), is larger than A (YES at the step S305), the payment process is impossible, and accordingly, the designation of n as the last digit number of the balance after the payment process is canceled, or the payment process is stopped (step S307). The y value generated here may be discarded as a fraction, or may be saved in the fraction accumulation unit 304.

When an amount equal to or larger than a predetermined one has already been accumulated in the fraction accumulation unit 304, instead of transferring the fraction y from the operational amount calculation section 402 to the fraction accumulation unit 304, the amount (10−y) may be transferred from the fraction accumulation unit 304 to the operational amount calculation section 402. In that case, the operational amount calculation unit 402 sets the subtraction amount to be (C+y−10) and notifies it to the operation section 401. The balance after the payment process obtained by operation at the operation section 401 becomes a value larger than (A−C) and having its last digit set at n.

It has been described above that, in the step S301, if the balance electronic money A is smaller than the designated subtraction amount C, the payment process cannot be further continued and accordingly is stopped, but a necessary amount may be transferred and added from the fraction accumulation unit 304 to the balance electronic money A. If the balance of electronic money A after the addition of the amount from the fraction accumulation unit 304 becomes larger than the designated subtraction amount C, continuation of the payment process becomes possible.

Further, in the step S304 in FIG. 6, if the balance of electronic money A is smaller than the subtraction amount (C+y), by transferring a necessary amount from the fraction accumulation unit 304 as described above, stop of the payment process (step S306) can be avoided.

In the payment process according to the present exemplary embodiment, as a result of that an amount to be subtracted from the balance of electronic money is calculated in a manner to set the last digit of the balance of electronic money after the payment process to be a number designated in advance, only one subtraction process needs to be performed in the operation section 401. For this reason, the number of times of subtraction processes can be smaller than in the method of the related technology where, after subtracting a payment amount from the balance, another subtraction process is further performed in order to set the last digit number to be a predetermined one. As a result, it is not necessary for the operation section 401 to wait for an order on whether or not to perform a further calculation for correcting the last digit of a number having resulted from the subtraction process, and accordingly, the payment process can be completed in a short time.

Further, differently from the related technology, it becomes unnecessary to comprise a constituent element for temporarily holding a fraction when it is generated, and accordingly, the present configuration can be simpler than that of the related technology.

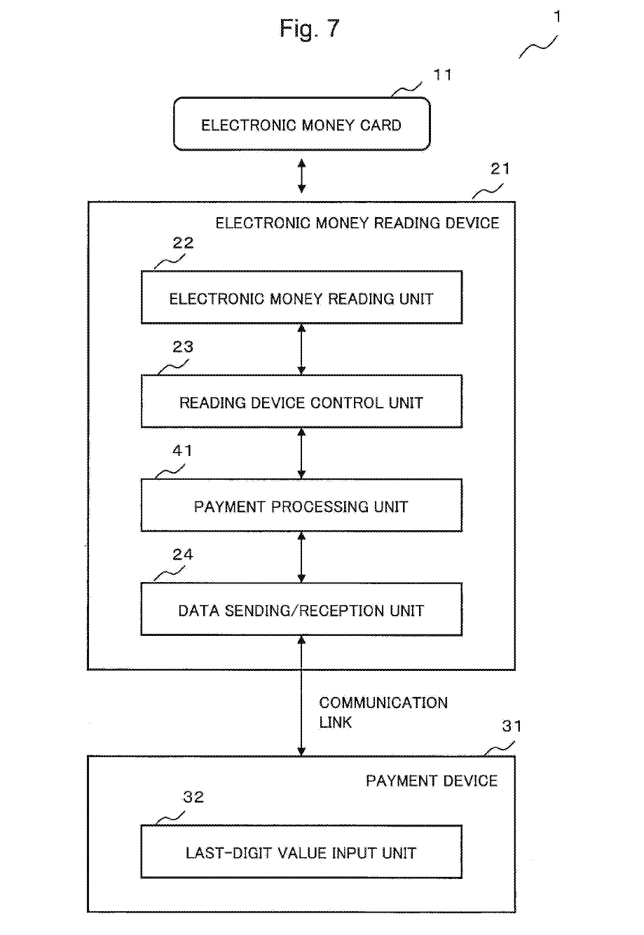

While, in the present exemplary embodiment, the configuration has been described to be such that the payment device 31 comprises the payment processing unit 41, the configuration is not limited to the described one. As shown in FIG. 7, the payment processing unit 41 may be comprised in the electronic money reading device 21.

Also the last-digit value input unit 32, through which the user designates a last digit number of the balance after the payment process, may be comprised in the electronic money reading device 21.

Further, in the present exemplary embodiment, a process of subtracting a payment amount from the balance of electronic money has been described, but a process to be performed is not limited to the described one. In a process of adding a payment amount to the balance of electronic money, an amount to be added may be adjusted before the addition, in a manner to set the last digit number to be a predetermined one, and then the adjusted amount may be added to the balance. In that case, an operational amount is calculated as follows.

Defining an amount whose addition is ordered by a payment request as C′, then with respect to the balance of electronic money A, the sum of A and C′, (A+C′), is divided by 10, and the remainder of the division is defined as x′.

When the last digit number is to be n for the balance after the payment process obtained by adding the ordered addition amount C′ to the balance of electronic money A, the remainder of dividing the result of subtracting n from the remainder x′, (x′−n), by 10 is defined as y′. Adding the result of subtracting y′ from the ordered addition amount C′, (C′−y′), to the balance of electronic money A, the last digit number of the balance after the payment process is set to be n. That is, what is required to be performed in the operational amount calculation section 402 is to calculate (C′−y′) and set it for the operational amount, and notify it to the operation section 401. The y′ value generated here may be discarded as a fraction, or may be saved in the fraction accumulation unit 304.

When an amount equal to or larger than a predetermined one has already been accumulated in the fraction accumulation unit 304, instead of transferring the fraction y′ from the operational amount calculation section 402 to the fraction accumulation unit 304, the amount (10−y′) may be transferred from the fraction accumulation unit 304 to the operational amount calculation section 402. In that case, the operational amount calculation section 402 sets the operational amount to be (C−y′+10), and notifies it to the operation section 401. The balance after the payment process obtained by operation in the operation section 401 becomes a value larger than (A+C′) and having its last digit set at n.

In the present exemplary embodiment, the above descriptions have been given of a process which is performed in a manner to set a predetermined digit of the balance of electronic money to be a predetermined number, where the predetermined digit is the last digit, but the process is not limited to the described one. The predetermined digit of the balance may be a plurality of digits including the last two or more digits. The process described in the present exemplary embodiment, which sets the last digit to be a predetermined number, can be extended to any plurality of digits. When the number of digits included in the predetermined digits is set to be k and an operational amount is accordingly calculated in a manner to set the last k-number of digits of the balance to be a predetermined number n, what is necessary is to change the step S302 of FIG. 6 into a step of setting the remainder of dividing (A−C) by 10 to the power of k for x, and the step S304 into a step of setting the remainder of dividing (x−n) by 10 to the power of k for y. In that case, each of x, y and n is an integer equal to or larger than zero and smaller than 10 to the power of k.

In the present exemplary embodiment, the above descriptions have been given of a payment process on an electronic money card constituted by embedding an electronic chip in a separated card, but the process is not limited to the described one. The present invention can be applied also to an electronic money medium constituted by embedding an electronic chip in an electronic device such as a cellular phone.

Further, in the present exemplary embodiment, the operational amount is calculated in a payment process performed on the balance in an electronic money card, in a manner to set a predetermined digit to be a predetermined number, the process is not limited to the described one. The present invention can be applied also to virtual money on which a payment process is performed by operating a terminal.

Further, a program for performing the above-described processing operations may be distributed by storing it in a computer-readable recording medium, such as a flexible disc, a CD-ROM (Compact Disk Read-Only Memory) and an MO (Magneto-Optical disk), and thereby, a device for executing the above-described processing operations may be configured by installing the program into a computer.

The present invention has been described above taking the above-described exemplary embodiments as typical examples. However, the present invention is not limited to the above-described exemplary embodiments. That is, various aspects of the present invention, which can be understood by those skilled in the art, can be implemented within the scope of the present invention.

This application is based upon and claims the benefit of priority from Japanese Patent Application No. 2013-197420, filed on Sep. 24, 2013, the disclosure of which is incorporated herein in its entirety by reference.

### INDUSTRIAL APPLICABILITY

Without being limited to the above-described exemplary embodiments, the present invention can be preferably applied to a payment system which performs payment while keeping a predetermined digit of the balance set to be a predetermined number.

### Reference Signs List

1, 1001 payment system
11, 2011 electronic money card
21, 2021 electronic money reading device
22, 2022 electronic money reading unit
23, 2023 reading device control unit
24, 2024 data sending/reception unit
31 payment device
32 last-digit value input unit
41 payment processing unit
101, 2101 balance holding section
301 payment data holding unit
302 payment amount holding unit
303 last-digit value holding unit
304 fraction accumulation unit
401, 2401 operation section
402 operational amount calculation section
403, 2403 buffer
1011 medium
1401 operation means
1402 operational amount calculation means
2001 charging system
2031 charging server
2041 charge processing unit
2301 charge data holding unit
2302 charge amount holding unit
2404 fraction determination unit
2405 fraction amount holding unit

1. A payment system comprising:
an operation unit that updates a balance held in a medium in the form of electronic data, by the use of an operational amount calculated based on both a payment amount and the balance, and thereby obtaining an updated balance; and
an operational amount calculation unit that calculates the operational amount in a manner to set a predetermined digit of the updated balance to be a predetermined number.

2. The payment system according to claim 1, further comprising a reading unit that reads the balance from the medium and inputs the balance to both the operation unit and the operational amount calculation unit.

3. The payment system according to claim 1, further comprising an input unit that inputs a number to be set for a predetermined digit, wherein
the operational amount calculation unit calculates the operational amount in a manner to set the predetermined digit of the updated balance to be the number inputted from the input unit.

4. The payment system according to claim 1, wherein,
when the predetermined digit of the updated balance is the last digit of the updated balance, and the predetermined number, the balance before update and the payment amount are represented by n, A and C, respectively:
in a case of subtracting the payment amount from the balance before update, defining the remainder of dividing (A−C) by 10 as x and the remainder of dividing (x−n) by 10 as y, the operational amount is calculated as (C+y), and then the updated balance is calculated as the result of subtracting the operational amount from the balance before update; and
in a case of adding the payment amount to the balance before update, defining the remainder of dividing (A+C) by 10 as x and the remainder of dividing (x−n) by 10 as y, the operational amount is calculated as (C−y), and then the updated balance is calculated as the result of adding the operational amount to the balance before update.

5. A payment device comprising:
an operation unit that updates a balance held in a medium in the form of electronic data, by the use of an operational amount calculated based on both a payment amount and the balance, and thereby obtaining an updated balance; and
an operational amount calculation unit that calculates the operational amount in a manner to set a predetermined digit of the updated balance to be a predetermined number.

6. The payment device according to claim 5, wherein,
when the predetermined digit of the updated balance is the last digit of the updated balance, and the predetermined number, the balance before update and the payment amount are represented by n, A and C, respectively:
in a case of subtracting the payment amount from the balance before update, defining the remainder of dividing (A−C) by 10 as x and the remainder of dividing (x−n) by 10 as y, the operational amount is calculated as (C+y), and then the updated balance is calculated as the result of subtracting the operational amount from the balance before update; and
in a case of adding the payment amount to the balance before update, defining the remainder of dividing (A+C) by 10 as x and the remainder of dividing (x−n) by 10 as y, the operational amount is calculated as (C−y), and then the updated balance is calculated as the result of adding the operational amount to the balance before update.

7. A payment method comprising:
calculating an operational amount based on both a payment amount and a balance held in a medium in the form of electronic data, in a manner to set a predetermined digit of an updated balance to be a predetermined number; and
updating the balance based on the calculated operational amount and thereby obtaining the updated balance.

8. The payment method according to claim 7, wherein,
when the predetermined digit of the updated balance is the last digit of the updated balance, and the predetermined number, the balance before update and the payment amount are represented by n, A and C, respectively, steps of the calculation include:
in a case where the payment amount is to be subtracted from the balance before update, defining the remainder of dividing (A−C) by 10 as x and the remainder of dividing (x−n) by 10 as y, calculating the operational amount as (C+y), and then calculating the updated balance as the result of subtracting the operational amount from the balance before update; and
in a case where the payment amount is to be added to the balance before update, defining the remainder of dividing (A+C) by 10 as x and the remainder of dividing (x−n) by 10 as y, calculating the operational amount as (C−y), and then calculating the updated balance as the result of adding the operational amount to the balance before update.

9. (canceled)

10. The payment system according to claim 4, further comprising a reading unit that reads the balance from the medium and inputs the balance to both the operation unit and the operational amount calculation unit.

11. The payment system according to claim 10, further comprising an input unit that inputs a number to be set for a predetermined digit, wherein
the operational amount calculation unit calculates the operational amount in a manner to set the predetermined digit of the updated balance to be the number inputted from the input unit.

12. The payment system according to claim 4, further comprising an input unit that inputs a number to be set for a predetermined digit, wherein
the operational amount calculation unit calculates the operational amount in a manner to set the predetermined digit of the updated balance to be the number inputted from the input unit.

13. The payment device according to claim 6, further comprising a reading unit that reads the balance from the medium and inputs the balance to both the operation unit and the operational amount calculation unit.

14. The payment device according to claim 13, further comprising an input unit that inputs a number to be set for a predetermined digit, wherein
the operational amount calculation unit calculates the operational amount in a manner to set the predetermined digit of the updated balance to be the number inputted from the input unit.

15. The payment device according to claim 6, further comprising an input unit that inputs a number to be set for a predetermined digit, wherein
the operational amount calculation unit calculates the operational amount in a manner to set the predetermined digit of the updated balance to be the number inputted from the input unit.
